(19) United States
(12) Patent Application Publication
(10) Pub. No.: US 2013/0195395 A1
(43) Pub. Date: Aug. 1, 2013

(54) Sensing fiber, coil of sensing fiber, and all-fiber current sensor

(71) Applicant: Yong Huang, Milpitas, CA (US)

(72) Inventor: Yong Huang, Milpitas, CA (US)

(21) Appl. No.: 13/374,999

(22) Filed: Jan. 27, 2012

(51) Int. Cl. G02B 6/00

(52) U.S. Cl. 385/11

(57) ABSTRACT

Embodiments of the present invention provide a sensing fiber, which includes a polarization-maintaining (PM) fiber being spun around a core thereof to have a first, a second, and a third sections, wherein the first section has an increasing rate of spin from a predetermined slow rate to a predetermined fast rate; the second section is spun at the predetermined fast rate; and the third section has a decreasing rate of spin from the predetermined fast rate to the predetermined slow rate. The first and third sections have a substantially same length and changes in rate of spin are substantially symmetric to each other. Embodiments of the present invention also provide a fiber coil made by the sensing fiber, with the first section and the third section being substantially overlapped along the coil, and provide an all-fiber current sensor employing the fiber coil.

### FIELD OF THE INVENTION

The present invention relates to a sensing fiber, a fiber coil made of the sensing fiber, and an all-fiber current sensor incorporating the fiber coil.

### BACKGROUND

Recently, all-fiber current sensor started to be used in monitoring high voltage and/or intelligent electric power grid. However, a key factor remains whether the type of all-fiber current sensor currently being used can withstand various interferences and be viable in long-term stability in performance, which may ultimately determine the practicality of a particular type of all-fiber current sensor and whether it gets wide spread application.

There are many research institutions currently working on all-fiber current sensors, most of which are based upon technologies traditionally used for optical fiber gyro. Most of the current sensors use a fiber coil of sensing fiber with a quarter-wave plate connected to a single-mode fiber with ultra-low birefringence. Even though some of the all-fiber current sensors have been in volume production and even put into live use, serious challenges still remain as to any repeatability of product performance and long-term stability thereof. In fact, when being made into coil, some of the imported or domestic fibers with ultra-low birefringence exhibit additional linear birefringence. The strong dependency of this linear birefringence on surrounding temperature, on top of the other factors such as vibration that may affect the fiber, causes instability of polarization characteristics of light propagating there inside.

An all-fiber current sensor works in the principle of the well-known Faraday effect. That is, a current propagating inside a wire or conductor will induce a magnetic field around the wire or conductor. Assuming an optical fiber is winded around the current-carrying wire or conductor, the magnetic field, through Faraday effect, may cause rotation of polarization direction of a light traveling inside the optical fiber. According to Faraday's law, the amount of rotation of polarization direction is directly proportional to the magnitude of electric current carried by the conductor or wire, through the magnitude of magnetic field caused thereby, and the total length of optical path traversed by the light. The Faraday effect may be expressed as θ=∫₀^{L} VHdl, wherein H is the strength of magnetic field under sensing, L is the length of sensing fiber, V is the Verdet coefficient of the sensing fiber, and θ is rotating angle of polarization of light inside the fiber.

Chinese patent application S/N: 200910262107.2 describes a sensing fiber adapted for making reflective-type all-current fiber sensor. The sensing fiber is made of a polarization-maintaining fiber with linear birefringence and includes an un-spun first section, followed by a second section which is spun around its core along its length with a spinning rate increasing from zero to a relatively high rate, and a third section spun at the constant relatively high rate. The sensing fiber terminates at the third section of fiber with a mirror.

### SUMMARY

Embodiments of the present invention provide a sensing fiber. The sensing fiber includes a polarization-maintaining (PM) fiber of birefringence being spun around a core thereof to have a first section, a second section, and a third section; the first section having an increasing rate of spin from a predetermined slow rate to a predetermined fast rate from a first end to a second end thereof; the second section continuing from the second end of the first section and continuing into a first end of the third section and being spun at a constant rate of the predetermined fast rate; and the third section having a decreasing rate of spin from the predetermined fast rate to the predetermined slow rate from the first end to a second end thereof, wherein the first section and the third section have a substantially same length and changes in rate of spin in the first section and the third section are symmetric to each other.

In one embodiment, the rate of spin in the first section increases linearly and the rate of spin in the third section decreases linearly. In another embodiment, the symmetry between changes in rate of spin in the first section and the third section is relative to a 50% value of the predetermined fast rate. In yet another embodiment, the predetermined slow rate is zero.

According to one embodiment, the PM fiber, before being spun around the core, has a beat length L between a fast mode and a slow mode thereof; wherein a pitch of spin in the second section that is spun at the predetermined fast rate is equal to or larger than 0.5 L; and wherein the first and third sections have a length that is larger than 50 L.

In one embodiment, when the first and third sections are overlapped with each other from respective the first ends to respective the second ends, a sum of rate of spin of the first section and the third section equals to the predetermined fast rate.

In another embodiment, a rate of change in rate of spin in the first section from the first end to the second end of the first section is substantially same in value, and opposite in sign, as a rate of change in rate of spin in the third section from the first end to the second end of the third section.

Embodiments of the present invention provides a sensing fiber coil, which includes a sensing fiber being winded into a coil having one or more turns, the sensing fiber being a polarization-maintaining (PM) fiber with birefringence that is spun around a core thereof to have a first section, a second section, and a third section; the first section having an increasing rate of spin from a predetermined slow rate to a predetermined fast rate from a first end to a second end thereof; the third section having a decreasing rate of spin from the predetermined fast rate to the predetermined slow rate from a first end to a second end thereof; and the second section being spun at a constant rate of the predetermined fast rate and connecting the second end of the first section to the first end of the third section, wherein the first section and the third section have a substantially same length and changes in rate of spin in the first section and the third section are symmetric to each other.

In one embodiment, inside the fiber coil, the first section and the third section are substantially overlapped with each other along the coil, with the first end of the first section and the first end of the third section being at a first position along the coil and the second end of the first section and the second end of the third section being at a second position along the coil.

In another embodiment, a sum of rate of spin of the first section and the third section, along the coil, equals substantially to the predetermined fast rate.

Embodiments of the present invention also provide an all-fiber current sensor that employs the sensing fiber coil made of the sensing fiber as being described in the present invention.

### BRIEF DESCRIPTION OF THE DRAWINGS

The present invention will be understood and appreciated more fully from the following detailed description of embodiments of the invention, taken in conjunction with the accompanying drawings of which:

FIG. 1 is a demonstrative illustration of a length-wise structure of a sensing fiber according to one embodiment of the present invention;

FIG. 2 is a demonstrative illustration of change in rate of spin of a sensing fiber along a length thereof according to one embodiment of the present invention;

FIG. 3 is a demonstrative illustration of change in rate of spin of a sensing fiber along a length thereof according to another embodiment of the present invention;

FIG. 4 is a demonstrative illustration of structure of a sensing fiber coil made by a sensing fiber according to one embodiment of the present invention; and

FIG. 5 is a demonstrative configuration of an all-fiber current sensor according to one embodiment of the present invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF EMBODIMENTS

In the following detailed description, numerous specific details are set forth in order to provide a thorough understanding of embodiments of the invention. However it will be understood by those of ordinary skill in the art that embodiments of the invention may be practiced without these specific details. In other instances, well-known methods and procedures have not been described in detail so as not to obscure the embodiments of the invention.

Some portions of the detailed description in the following are presented in terms of algorithms and symbolic representations of operations on electrical and/or electronic signals, and optical signals. These algorithmic descriptions and representations may be the techniques used by those skilled in the electrical and electronic engineering and optical communication arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or electronic or optical signals capable of being stored, transferred, combined, compared, converted, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

In the following description, various figures, diagrams, flowcharts, models, and descriptions are presented as different means to effectively convey the substances and illustrate different embodiments of the invention that are proposed in this application. It shall be understood by those skilled in the art that they are provided merely as exemplary samples, and shall not be constructed as limitation to the invention.

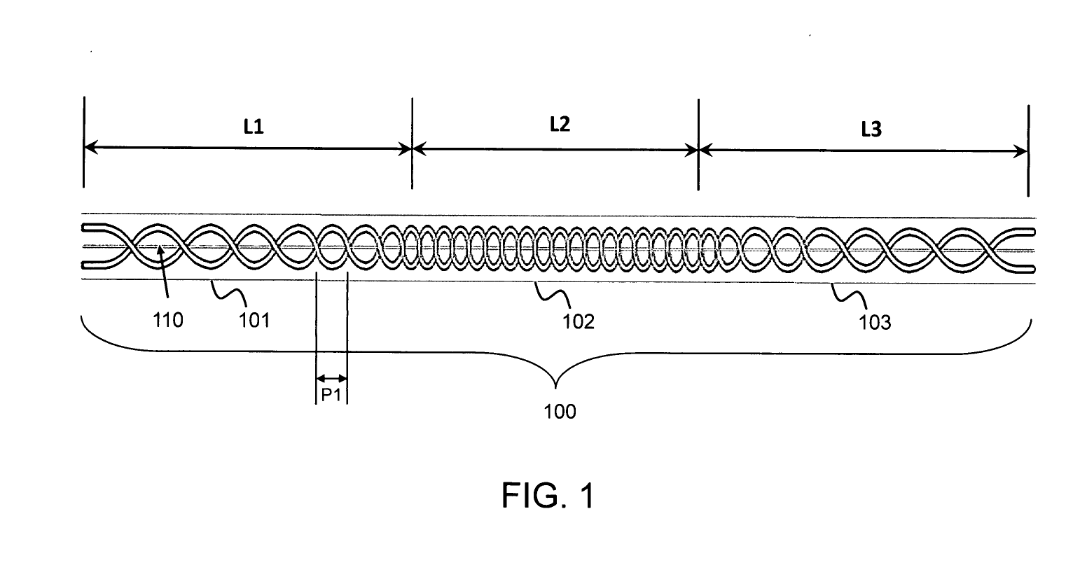

FIG. 1 is a demonstrative illustration of a length-wise structure of a sensing fiber 100 according to one embodiment of the present invention. Sensing fiber 100 may be made of, in one embodiment, a fiber with high birefringence, such as a polarization-maintaining (PM) fiber, being spun around its core 110 along a length thereof in a predetermined manner. In another embodiment, sensing fiber 100 may be made of or manufactured from a birefringent preform. During manufacturing, while being drawn into sensing fiber 100, a spinning motion may be applied to sensing fiber 100 or to the birefringent preform around a core thereof The rate of spin may change during the drawing in a controlled or predetermined manner. For example, the rate of spin may start from zero or a very slow rate to increase gradually to a relatively fast rate to create a first section 101 of fiber 100 with increasing rate of spin; then stay or remain at the relatively fast rate for a certain period of time or time duration to create a second section 102 of fiber 100 with constant rate of spin; and finally decrease gradually to zero or a very slow rate to create a third section 103 of fiber 100 with decreasing rate of spin. In FIG. 1, for illustration purpose, the twisted pair of lines may be considered as representing changes in birefringence along fiber 100 or other relevant characteristics of the fiber.

When a linearly polarized light is launched into sensing fiber 100, eigenstate of the light evolutes from a linear polarization state, to an elliptical or circular polarization state, and subsequently back to a linear polarization state. The evolution of eigenstate of light is induced by a slow variation of intrinsic structure of sensing fiber 100 from linear anisotropy at the un-spun portions of the two ends of the fiber to elliptical or circular anisotropy at the fast-spun middle portion of the fiber. The evolution of eigenstate of light inside sensing fiber 100 enables optical power coupling among local eigenstates. As a result, relative powers in these local eigenstates vary as a function of distance along the length of fiber. So is the extinction ratio of output state of polarization (SOP), which varies as a function of rate of spin along the length of fiber.

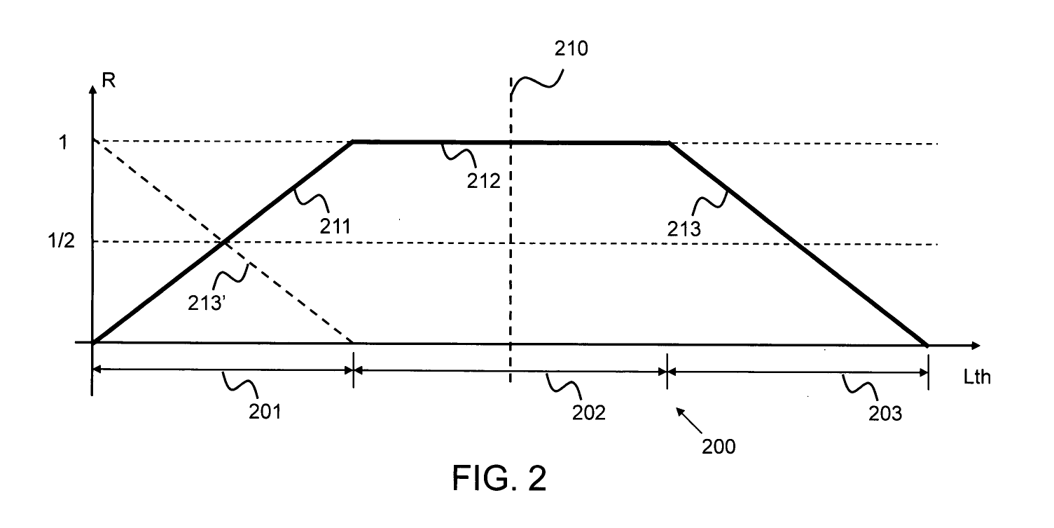

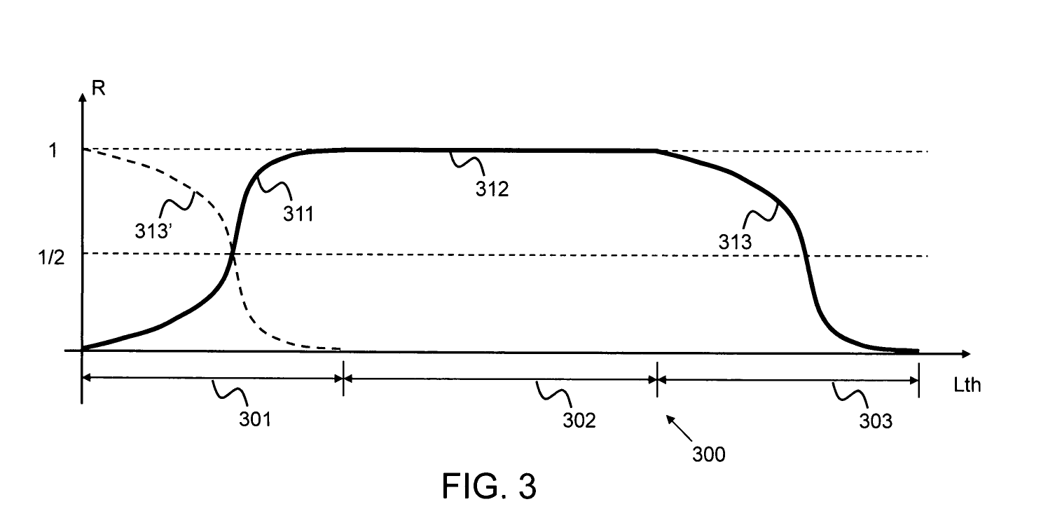

Referring back to FIG. 1, sensing fiber 100 may include first section 101 having a length L1, second section 102 having a length L2, and third section 103 having a length L3. According to one embodiment, length L3 of third section 103 may be made substantially the same as length L1 of first section 101. First section 101 of sensing fiber 100 may be a section where fiber 100 is spun at a rate of spin (or rate of rotation) that increases from a very slow rate, preferably zero, to a relatively fast rate. Preferably, the rate of spin increases gradually in first section 101 without sudden acceleration or deceleration such as, for example, linearly as being demonstratively illustrated in FIG. 2. However, embodiment of the present invention is not limited in this respect and the change in rate of spin may not need to be linear, as being demonstratively illustrated in FIG. 3. Second section 102 of sensing fiber 100 may be a section where fiber 100 remains or stays being spun at the predetermined relatively fast rate that is reached at the end of first section 101. In other words, fiber 100 remains or stays being spun at a constant rate of spin or rate of rotation throughout section 102. Third section 103 of sensing fiber 100 may be a section where the rate of spin of fiber 100 decreases from the predetermined relatively fast rate to a very slow rate, preferably zero. Preferably, the decrease in rate of spin in third section 103 is gradual and/or linear, similar to that in first section 101, without sudden acceleration or deceleration. According to one embodiment, the decrease in rate of spin in third section 103 may be made substantially symmetric to the increase in rate of spin in first section 101. Here, the symmetry is with respect to, or relative to, a 50% value of the predetermined relatively fast rate of spin in second section 102 of fiber 100, as being described below in more details with reference to FIG. 2 and FIG. 3. In addition, a pitch of spin P1 in section 101 and section 103 changes with the change in rate of spin while a pitch of spin in section 102 remains constant because of the constant rate of spin. For example, a pitch length in section 102 may be fixed within about 3˜5 mm while a pitch length in section 101 or section 103 may change from around 3 mm to infinite (rate of spin zero).

FIG. 2 is a demonstrative illustration of change in rate of spin of a sensing fiber 200 along a length thereof according to one embodiment of the present invention. In FIG. 2, x-axis Lth denotes a length along sensing fiber 200 and y-axis R denotes a normalized rate of spin of sensing fiber 200 around a core thereof Assuming sensing fiber 200 has three sections of a first section 201, a second section 202, and a third section 203, the normalization is made with respect to the relatively fast rate at the constant rate of spin in second section 202. In one embodiment, the rate of spin of sensing fiber 200 changes linearly both in section 201 and in section 203. More specifically, the rate of spin (or rate of rotation) in section 201 increases linearly from zero, along a straight line 211, to a normalized high rate 1. The rate of spin remains at the normalized high rate 1 throughout section 202 along a straight line 212. In section 203, the rate of spin decreases linearly along a straight line 213 from the normalized high rate 1 to zero.

According to one embodiment of the present invention, change 213 in rate of spin in section 203 may be made symmetric or at least substantially symmetric to change 211 in rate of spin in section 201. In other words, assuming section 203 is parallel shifted to be placed overlapping with section 201, change 213 in rate of spin is now represented by straight line 213′ in FIG. 2 which is symmetric to change 211 relative to (or with respect to) a 50% value of the normalized high rate 1. Moreover, in the linear rate change situation as in FIG. 2, since section 201 and section 203 of sensing fiber 200 are made substantially the same length, change 213 and change 211 are also symmetric relative to or with respect to the center point of section 202, which is represented by line 210 in FIG. 2.

Furthermore, since the rate of spin in section 201 is made symmetric to the rate of spin in section 203, a pitch of spin at the beginning of section 201 is the same as a pitch of spin at the end of section 203. A pitch of spin at the end of section 201 is also the same as a pitch of spin at the beginning of section 203. Assuming sensing fiber 200, at the beginning of section 201 or at the end of section 203 where the fiber is un-spun with the rate of spin being at zero and thus is a regular PM fiber, has a beat length L between a fast mode and a slow mode, according to one embodiment, the smallest pitch in sensing fiber 200, which is a pitch at the end of section 201 or a pitch in section 202 or a pitch at the beginning of section 203, is made no smaller than 50% of the beat length L in order to avoid dramatic increase in loss of light propagation. According to another embodiment, length of section 201 and length of section 203 may be made substantially the same and are no less than 50 times the beat length L.

FIG. 3 is a demonstrative illustration of change in rate of spin of a sensing fiber 300 along a length thereof according to another embodiment of the present invention. Similar to FIG. 2, in FIG. 3 x-axis Lth denotes a length along sensing fiber 300 and y-axis R denotes a normalized rate of spin of sensing fiber 300 around a core thereof and sensing fiber 300 is assumed to have three sections of a first section 301, a second section 302, and a third section 303. The rate of spin increases along a non-linear curve 311 in first section 301 of fiber 300 from a relatively slow rate such as zero to a normalized high rate 1 and decreases along a non-linear curve 313 in third section 303 of fiber 300 from the normalized high rate 1 to the relatively slow rate such as zero again. The rate of spin remains constant throughout second section 302 at the normalized high rate 1 along a straight line 312. Here, normalization of rate of spin is made with respect to the rate of spin in second section 302.

According to one embodiment of the present invention, changes 311 and 313 in rate of spin are made symmetric or at least substantially symmetric with respect to a 0.5 normalized rate of spin line. As being demonstratively illustrated in FIG. 3 by a non-linear curve 313′ that represents change 313 in section 303 when section 303 is being parallel shifted to be placed overlapping with section 301, changes 313 and 311 are symmetric relative to (with respect to) the 0.5 normalized rate of spin line. It is noted here, in this case, that the symmetric nature of changes 311 and 313 is no longer with respect to the center point of the middle second section 302 of fiber 300, as being the case in FIG. 2.

In other words, as being demonstratively illustrated in FIG. 3, a rate of change in rate of spin in first section 301 of fiber 300 may be substantially same in value but opposite in sign as a rate of change in rate of spin in third section 303 of fiber 300. Therefore, when first section 301 and third section 303 of sensing fiber 300 are placed to overlap substantially with each other from their respective first ends to their respective second ends, as being the case when a fiber coil is made, a sum of rate of spin of first section 301 and third section 303 equals or substantially equals to the normalized fast rate 1.

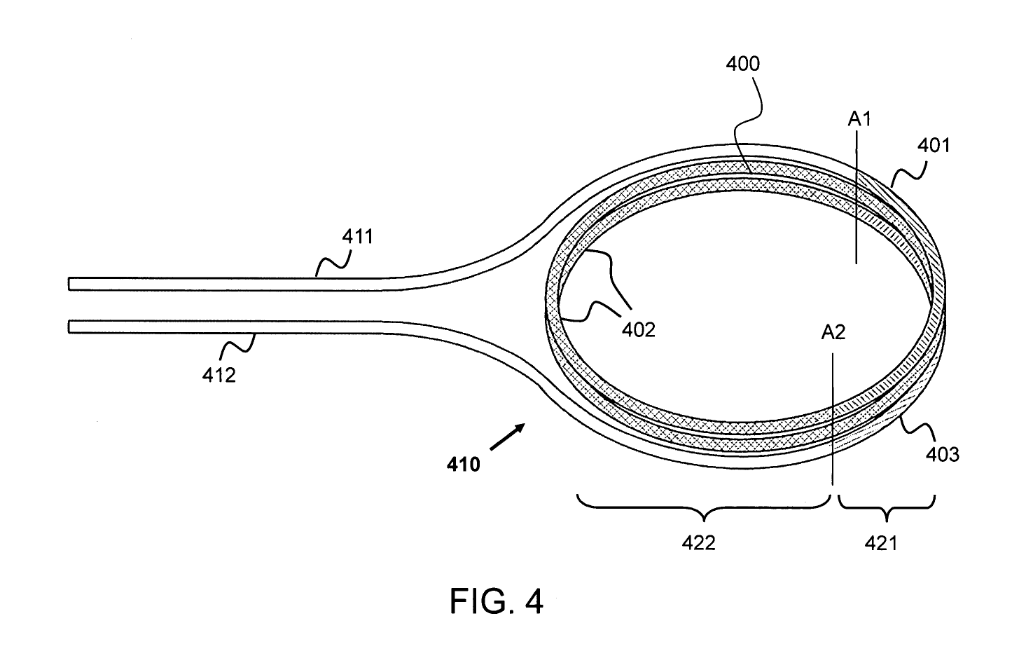

FIG. 4 is a demonstrative illustration of structure of a sensing fiber coil 410 made by a sensing fiber according to an embodiment of the present invention. More specifically, sensing fiber coil 410 may include one or more turns of a sensing fiber 400. Sensing fiber 400 may be same or have the same structure as sensing fiber 100, 200, or 300 described above in detail together with FIG. 1, FIG. 2, or FIG. 3. For example, sensing fiber 400 may be a polarization-maintaining (PM) fiber with high birefringence that is spun around a core thereof with a varying rate of spin along the length of the fiber, similar to sensing fiber 100 being illustrated in FIG. 1. More specifically, sensing fiber 400 may include a first section 401, a second section 402, and a third section 403 with first section 401 having an increasing rate of spin from a first end (zero rate of spin) to a second end (normalized 1 rate of spin) thereof; second section 402 having a constant rate of spin (normalized 1 rate of spin); and third section 403 having a decreasing rate of spin from a first end (normalized 1 rate of spin) to a second end (zero rate of spin) thereof.

According to one embodiment, first section 401 and third section 403 of sensing fiber 400 may have a substantially same length and are substantially overlapped in space with each other along coil 410. More specifically, as being demonstratively illustrated in FIG. 4, the first end (of zero rate of spin) of first section 401 may be aligned with the first end (of normalized 1 rate of spin) of third section 403 at a point A1 along coil 410, and the second end (of normalized 1 rate of spin) of first section 401 may be aligned with the second end (of zero rate of spin) of third section 403 at a point A2 along coil 410. In addition, sensing fiber coil 410 may be connected to a first input/output fiber 411, preferably PM fiber, at the first end (of zero rate of spin) of first section 401 and connected to a second input/output fiber 412, preferably PM fiber, at the second end (of zero rate of spin) of third section 403.

When a light propagates inside a sensing fiber, such as sensing fiber 400, polarization of the light may rotate along the length of the fiber through Faraday effect caused by a magnetic field wherein the fiber is situated for sensing the magnetic field. The amount of polarization rotation θ may be expressed as θ=∫₀^{Lf} VHdl, wherein H is the strength of the magnetic field under sensing, Lf is the length of sensing fiber, and V is a Verdet coefficient of the sensing fiber. Verdet coefficient V is generally directly proportional to the rate of spin of the sensing fiber, and may be expressed as V(l)=Vₘₐₓ×R(l) with Vₘₐₓ being the maximum value of Verdet coefficient and R(l) being a normalized rate of spin of the sensing fiber. R(l) changes along a length l and ranges from 0 to 1.

Reference is now made back to FIG. 4. Verdet coefficient along first section 401 of sensing fiber 400 may be expressed as V=Vₘₐₓ×R(l) with R(l) representing a normalized rate of spin from the first end to the second end of first section 401 and the rate of spin at the first end being 0 and at the second end being 1. Because rate of spin in third section 403 of sensing fiber 400 is made symmetric to the rate of spin in first section 401, normalized rate of spin in third section 403 from a first end to a second end may be expressed as 1−R(l). Verdet coefficient along third section 403 may therefore be expressed as V=Vₘₐₓ×(1−R(l)) with the rate of spin at the first end being 1 and at the second end being 0. As being demonstratively illustrated in FIG. 4, when sensing fiber 400 is winded into fiber coil 410, first section 401 and third section 403 have the same length and are substantially overlapped along the coil. Polarization rotation produced by combined first section 401 and third section 403 may be expressed asθ=∫₀^{Lf}(Vₘₐₓ×R(l)+Vₘₐₓ×(1−R(l))Hdl=∫₀^{Lf}VₘₐₓHdl which may be same as polarization rotation that would occur inside a portion of second section 402 of sensing fiber, with a length Lf same as that of first section 401 and third section 403.

As being demonstratively illustrated in FIG. 4, fiber coil 410 may have a first portion 421 (from point A1 to point A2 clockwise) and a second portion 422 (from point A2 to point A1 clockwise). First portion 421 of fiber coil 410 may include first section 401, third section 403, and a number of turns of second section 402. On the other hand, second portion 422 of fiber coil 410 may include a number of turns of second section 402 that is one turn more than the number of turns of section 402 in first portion 421 of fiber coil 410.

As being discussed above, first section 401 and third section 403 of sensing fiber 400, being substantially overlapped in space, may produce a total polarization rotation that is equivalent to that of one turn of second section 402 in first portion 421 of fiber coil 410. In other words, first portion 421 of coil 410 may not be distinguished from second portion 422 of coil 410 and as far as degree of polarization rotation caused by Faraday effect is concerned may be viewed as being made of a same number of turns of second section 402 of sensing fiber 400 as that of second portion 422 of fiber coil 410. The above distinctive property of fiber coil 410 is important in that the fiber coil 410 now functions as a “closed loop” which provides sensing fiber coil 410 with immunity to any interference that may come from outside the closed loop of sensing fiber coil 410.

Here, it is noted that for illustration purpose FIG. 4 shows only two turns of section 402 (or equivalent as in first portion 421) in fiber coil 410. In practice, the number of turns made by sensing fiber 400 (mainly section 402) may vary from one (1) to tens of turns, depending upon the specific sensing needs, and a diameter of fiber coil 410 may vary as well such as varying from around 20 cm to around 40 cm or even a few meters. Moreover, the length of section 402 of sensing fiber 400 may be longer than, or far longer than the length of section 401 and section 403. For example, the length of section 401 and 403 may be around 15˜60 cm, while the length of section 402 may be around 100˜4000 cm.

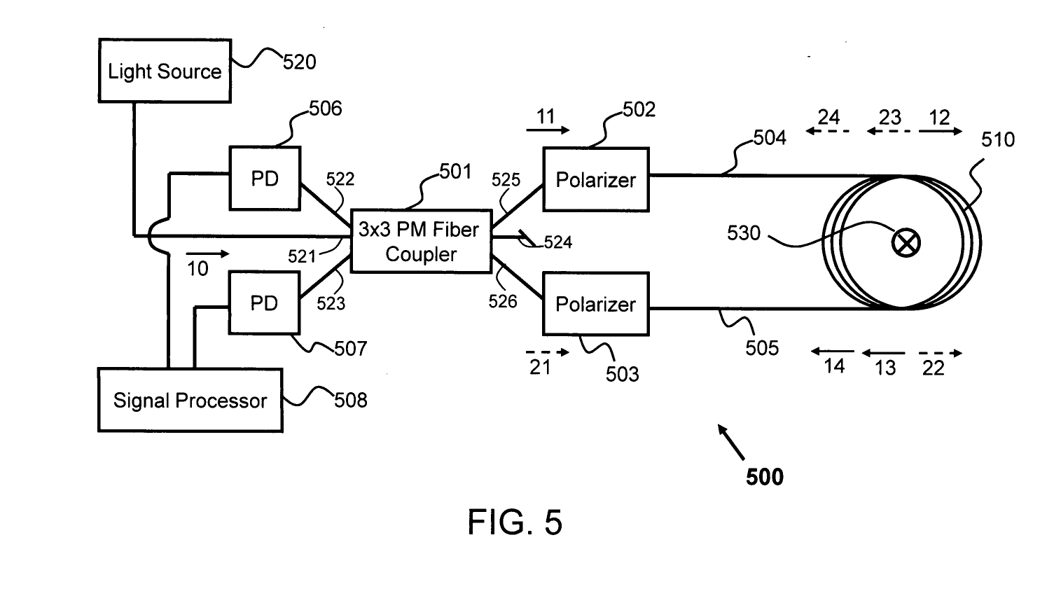

FIG. 5 is a demonstrative configuration of an all-fiber current sensor according to one embodiment of the present invention. All-fiber current sensor 500 may employ a sensing fiber coil 510 that may be the same as sensing fiber coil 410 as being described above. In addition, all-fiber current sensor 500 may include a three-by-three (3×3) polarization-maintaining (PM) fiber coupler 501. PM fiber coupler 501 may have a first set of ports 521, 522, and 523 on one side (first side) and a second set of ports 524, 525, and 526 on the other side (second side) and may work either as a coupler or a splitter. Ports 521-526 may function or be used as input and/or output ports, and some of them may include pigtail fibers. For example, ports 521, 525, and 526 may include PM pigtail fibers and ports 522, 523, and 524 may include either PM or regular single mode pigtail fibers.

Current sensor 500 may include a light source 520, being connected to port 521 of the first side of coupler 501; first and second photon-detectors 506 and 507, being connected respectively to ports 522 and 523 of the same side; and a signal processor 508, being connected to both first and second photon-detectors 506 and 507. Between light source 520 and port 521 an optical isolator may be used in order to increase stability of light source 520 during operation. Current sensor 500 may also include first and second polarizers 502 and 503, being connected respectively to ports 525 and 526 of the second side of coupler 501. The end of polarization-maintaining fiber at port 524 of the second side may be treated with an anti-reflection coating material and/or may be cut in an angle, such that back-reflections of light or optical signal from the end of the fiber may be substantially reduced, and/or preferably eliminated. Alternatively, as in one embodiment, port 524 may be used as a controlling port for monitoring and based thereupon increasing stability of power output from light source 520 through, e.g., some feedback control mechanism.

According to one embodiment of the present invention, sensing fiber coil 510 may be connected to first and second polarizers 502 and 503, respectively, through two pigtail PM fibers 504 and 505. Comparing with conventional all-fiber current sensors that use traditional sensing fiber coil, because sensing fiber coil 510 provides polarization conversion of light from linear polarization to elliptical or circular polarization and subsequently back to linear polarization, which are normally not provided by a traditional sensing fiber coil, no quarter-wave plates are needed between polarizers 502/503 and sensing fiber coil 510. As a result, all-fiber current sensor 500 may inherently have lower insertion loss, improved system reliability because of less loss components used, and, when being compared with other reflective-type current sensors, is less temperature sensitive and has better long-term stability. Current sensor 500 requires no reflective-mirror or coating at the end of the sensing fiber coil.

During operation, light source 520 may launch an optical signal into port 521 of coupler 501. The optical signal may preferably be a linearly polarized light, for example, x-direction (perpendicular to this paper) polarized light 10. In one embodiment, a non-polarized light may become linearly polarized after passing through a polarizer that may be inserted (not shown) between light source 520 and port 521 of coupler 501. Light 10 may split into three lights including lights 11 and 21, inside coupler 501, of both x-direction polarized and lights 11 and 21 may propagate toward polarizers 502 and 503, via ports 525 and 526, respectively.

Polarizer 502 may align linearly polarized light 11, or convert a non-polarized light or strengthen a weakly polarized light into linearly polarized light, with a main polarization axis of pigtail PM fiber 504 connecting to a first port of fiber coil 510. Similarly, polarizer 503 may align linearly polarized light 21, or convert a non-polarized light into linearly polarized light, with a main polarization axis of pigtail PM fiber 505 connecting to a second port of fiber coil 510.

Current sensing fiber coil 510 may be winded around a medium such as a conductor or wire 521 that carries a current under measurement or detection or test. Current carried inside conductor 530 may create a magnetic field along the optical path of fiber coil 510 causing rotation of polarization direction of lights propagating inside, which is known in the art as Faraday effect.

Sensing fiber coil 510 may be a PM fiber of birefringence being spun around its core, along a length thereof, to have a first section, a second section, and a third section. In fact, sensing fiber coil 510 may be a same fiber coil as fiber coil 410 illustrated in FIG. 4. First section of sensing fiber coil 510 may have an increasing rate of spin from a very slow rate such as zero to a relatively fast rate; second section of sensing fiber coil 510 may have a constant rate of spin at the predetermined relatively fast rate; and third section of sensing fiber coil 510 may have a decreasing rate of spin from the predetermined relatively fast rate to zero.

More specifically, first section of sensing fiber coil 510 may convert linearly polarized input light 11 coming from polarizer 502 into a right circularly polarized light 12. Right circularly polarized light 12, after propagating through fiber coil 510, may experience a first phase shift to become a right circularly polarized light 13. Right circularly polarized light 13 may then be converted, by the third section of sensing fiber coil 510, back into an x-direction linearly polarized light 14 carrying a first phase information which is directly related to the magnitude of current inside conductor 530.

Similarly, third section of sensing fiber coil 510 may convert linearly polarized input light 21 coming from polarizer 503 into a left circularly polarized light 22. Left circularly polarized light 22, after propagating through fiber coil 510 in a direction opposite to that of light 12, may experience a second phase shift to become a left circularly polarized light 23. The second phase shift may be different from the first phase shift. Left circularly polarized light 23 may then be converted, by the first section of sensing fiber coil 510, back into an x-direction linearly polarized light 24 carrying a second phase information which is also related to the magnitude of current inside conductor 530.

Linearly polarized lights 14 and 24 may subsequently pass through PM pigtail fibers 505 and 504 and be launched into coupler 501, via ports 526 and 525, respectively. Coupler 501 may create coherent interference between linearly polarized lights 14 and 24. Coming out of coupler 501, a combined light of lights 14 and 24 may then propagate along ports 522/523 to photon-detectors 506/507, wherein it is converted into a photocurrent. Electrical outputs of photon-detectors 506/507 are connected to signal processor 508, which receives photocurrents from photon-detectors 506 and 507, processes information carried by the photocurrents, and determines the amount of current carried inside by conductor 530.

Here, it is worth noting that sensing fiber coil 410 (FIG. 4) of present invention may be used in other types of configuration of all-fiber current sensors. As a non-limiting example, a configuration similar to that illustrated in FIG. 5 may be used, wherein polarizers 502 and 503 may be placed to the left side of PM fiber coupler 501, instead of to the right side thereof, without impacting functionality of the all-fiber current sensor.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the spirit of the invention.

What is claimed is:

1. A sensing fiber comprising a polarization-maintaining (PM) fiber of birefringence being spun around a core thereof to have a first section, a second section, and a third section; said first section having an increasing rate of spin from a predetermined slow rate to a predetermined fast rate from a first end to a second end thereof; said second section continuing from said second end of said first section and continuing into a first end of said third section and being spun at a constant rate of said predetermined fast rate; and said third section having a decreasing rate of spin from said predetermined fast rate to said predetermined slow rate from said first end to a second end thereof, wherein said first section and said third section have a substantially same length and changes in rate of spin in said first section and said third section are symmetric to each other.

2. The sensing fiber of claim 1, wherein said rate of spin in said first section increases linearly and said rate of spin in said third section decreases linearly.

3. The sensing fiber of claim 1, wherein said symmetry between changes in rate of spin in said first section and said third section is relative to a 50% value of said predetermined fast rate.

4. The sensing fiber of claim 1, wherein said predetermined slow rate is zero.

5. The sensing fiber of claim 1, wherein said PM fiber, before being spun around said core, has a beat length L between a fast mode and a slow mode thereof; wherein a pitch of spin in said second section that is spun at said predetermined fast rate is equal to or larger than 0.5 L; and wherein said first and third sections have a length that is larger than 50 L.

6. The sensing fiber of claim 1, wherein when said first and third sections are overlapped with each other from respective said first ends to respective said second ends, a sum of rate of spin of said first section and said third section equals to said predetermined fast rate.

7. The sensing fiber of claim 1, wherein a rate of change in rate of spin in said first section from said first end to said second end of said first section is substantially same in value, and opposite in sign, as a rate of change in rate of spin in said third section from said first end to said second end of said third section.

8. A sensing fiber coil comprising a sensing fiber being winded into a coil having one or more turns, said sensing fiber being a polarization-maintaining (PM) fiber of birefringence that is spun around a core thereof to have a first section, a second section, and a third section; said first section having an increasing rate of spin from a predetermined slow rate to a predetermined fast rate from a first end to a second end thereof; said third section having a decreasing rate of spin from said predetermined fast rate to said predetermined slow rate from a first end to a second end thereof; and said second section being spun at a constant rate of said predetermined fast rate and connecting said second end of said first section to said first end of said third section, wherein said first section and said third section have a substantially same length and changes in rate of spin in said first section and said third section are symmetric to each other.

9. The sensing fiber coil of claim 8, wherein said first section and said third section are substantially overlapped with each other along said coil, with said first end of said first section and said first end of said third section being at a first position along said coil and said second end of said first section and said second end of said third section being at a second position along said coil.

10. The sensing fiber coil of claim 9, wherein said rate of spin in said first section increases linearly and said rate of spin in said third section decreases linearly.

11. The sensing fiber coil of claim 9, wherein said symmetry between change in rate of spin in said first section and change in rate of spin in said third section is with respect to a 50% value of said predetermined fast rate.

12. The sensing fiber coil of claim 9, wherein a sum of rate of spin of said first section and said third section, along said coil, equals substantially to said predetermined fast rate.

13. The sensing fiber coil of claim 9, wherein said predetermined slow rate is zero.

14. The sensing fiber coil of claim 8, wherein said PM fiber, before being spun around said core, has a beat length L between a fast mode and a slow mode thereof, and wherein a pitch of spin in said second section being spun at said predetermined fast rate is equal to or larger than 0.5 L, and said first section and said third section have a length that is larger than 50 L.

15. The sensing fiber coil of claim 8, wherein said coil has a diameter between about 20 cm to about 400 cm.

16. The sensing fiber coil of claim 8, wherein said first and third sections have a length between about 15 cm and about 60 cm, and said second section has a length between about 100 cm and about 4000 cm.

17. A current sensing device, comprising:
a three-by-three (3×3) polarization-maintaining (PM) fiber coupler;
a light source and at least one photon-detector connected to a first side of said 3×3 PM fiber coupler; and
a fiber coil connected to a second side of said 3×3 PM fiber coupler,
wherein said fiber coil is made from a polarization-maintaining fiber of birefringence that is spun around a core thereof to have a first section, a second section, and a third section; wherein said first section has an increasing rate of spin from a predetermined slow rate to a predetermined fast rate from a first end to a second end thereof; said second section continues from said second end of said first section and continues into a first end of said third section and is spun at a constant rate of said predetermined fast rate; and said third section has a decreasing rate of spin from said predetermined fast rate to said predetermined slow rate from said first end to a second end thereof; wherein said first section is substantially overlapped with said third section along said fiber coil with said first end of said first section being at a first position same as said first end of said third section and with said second end of said first section being at a second position same as said second end of said third section, and wherein changes in rate of spin in said first section and said third section are symmetric to each other.

18. The current sensing device of claim 17, wherein said first end of said first section is a first port of said fiber coil and said second end of said third section is a second port of said fiber coil, further comprising:
a first polarizer connected between said first port of said fiber coil and a first port of said second side of said 3×3 PM fiber coupler; and
a second polarizer connected between said second port of said fiber coil and a second port of said second side of said 3×3 PM fiber coupler,
wherein said first polarizer is adapted to convert a first optical signal into a first linearly polarized light to be provided to said first port of said fiber coil; and said second polarizer is adapted to convert a second optical signal into a second linearly polarized light to be provided to said second port of said fiber coil; said fiber coil is adapted to convert said first and second linearly polarized lights into first and second circularly polarized lights, respectively, to propagate therein in opposite directions and is adapted to convert said first and second circularly polarized lights, after propagating through said fiber coil, into third and fourth linearly polarized lights, respectively.

19. The current sensing device of claim 17, wherein said rate of spin in said first section of said PM fiber in said fiber coil increases linearly and said rate of spin in said third section of said PM fiber in said fiber coil decreases linearly.

20. The current sensing device of claim 17, wherein a rate of change in rate of spin in said first section from said first end to said second end of said first section is substantially same in value, and opposite in sign, as a rate of change in rate of spin in said third section from said first end to said second end of said third section.
